(19) United States
(12) Patent Application Publication
(10) Pub. No.: US 2018/0091369 A1
(43) Pub. Date: Mar. 29, 2018

(54) TECHNIQUES TO DETECT ANOMALIES IN SOFTWARE DEFINED NETWORKING ENVIRONMENTS

(71) Applicant: INTEL CORPORATION, SANTA CLARA, CA (US)

(72) Inventors: ANDREW CUNNINGHAM, ENNIS (IE); BEN-ZION FRIEDMAN, JERUSALEM (IL); JOHN BROWNE, LIMERICK (IE); ROBIN GILLER, ENNIS (IE); ALEXANDER LECKEY, KILCOCK (IE); ELIEZER TAMIR, BAIT SHEMESH (IL)

(73) Assignee: INTEL CORPORATION, SANTA CLARA, CA (US)

(21) Appl. No.: 15/279,386

(22) Filed: Sep. 28, 2016

(51) Int. Cl. H04L 12/24; H04L 12/26

(52) U.S. Cl. CPC H04L 41/0816; H04L 43/16; H04L 41/20; H04L 41/5038; H04L 41/5009; H04L 41/5019

(57) ABSTRACT

Embodiments may be generally directed to techniques to receive rate meter information indicating an occurrence of a rate meter event, the rate meter event determined by a rate meter associated with a network element in a software defined network (SDN) environment. determine a requirement for a service provided by the network element is not met based on the rate meter event detected by the rate meter. Embodiments may also include techniques to determine a corrective action based on the requirement not met, the corrective action to cause the requirement to be met for the service provided by the network element in the SDN environment and cause the correct action to be performed for the network element.

### TECHNICAL FIELD

Embodiments described herein generally relate to rate meters detecting anomalies in software defined networks and performing corrective actions.

### BACKGROUND

The utilization of virtual environments to provide services and capabilities is becoming more and more prevalent in today's computing environment. Virtual environments are being used to provide services with high availability and traffic latency requirements. For example, telecommunication companies are using these environments to provide telecom services to users. Systems that provide these services are constantly monitored to ensure that the services are being provided and meet the stringent requirements stipulated by the customers. Embodiments are directed to solving problems related to meeting these requirements when providing services.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1A illustrates an example of a networking system.

FIG. 1B illustrates an example of a system.

FIG. 2 illustrates an example of a logic flow.

FIGS. 3A/3B illustrates an example of system.

FIG. 4A illustrates an example of a logic flow.

FIG. 4B illustrates an example of a logic flow.

FIG. 5 illustrates an example of a computing system.

FIG. 6 illustrates an example of a computer architecture.

### DETAILED DESCRIPTION

Various embodiments may be directed to systems, apparatuses, devices, logic, methods, and so forth to use rate limit information to make intelligent decisions to process information in networking environments. For example, the rate limit information may be used to ensure that specified requirements, such as those stipulated in a Service Level Agreement (SLA), are maintained in a Software Defined Network (SDN) environment. These requirements may include ensuring that bandwidth for traffic processed by network elements is maintained above a minimum threshold value, within a minimum threshold and maximum threshold value, and/or below a maximum threshold value. The threshold values may be based on a SLA, for example, and set such that network elements processing on a node continue to meet the specified requirements. If these requirements are not being met, embodiments may include performing one or more mitigating or corrective actions to ensure the requirements do get met by the system and service provider.

In one example, embodiments may include monitoring egress ports of a node by rate meters to determine throughput for network elements. If the monitored throughput is greater than or less than a throughput threshold value, e.g. not within threshold values set for the network element, a rate meter event may be generated. An indication of the rate meter event may be communicated or sent to a controller coupled with the node which may receive the indication in rate meter information. The rate meter information may identify an associated network element and provide an indication of an extent to which throughput is above or below the threshold value. For example, the rate meter information may specify a particular virtual networking function (VNF), whether a throughput for traffic associated with the VNF is above or below a threshold value, an indication of a period of time the traffic is above or below a threshold value, and indication of how much the throughput is above or below the threshold value.

Embodiments may also include using the rate meter information to determine and cause a corrective action to be performed such that the requirement for the network element is met. For example, embodiments may include moving the network element associated with the rate meter event to a different node when the current node cannot meet the requirement. In another example, the logic may include moving another network element on the same node as the network element associated with the rate meter event to another node. Moving a different network element may occur when moving the network element associated with the rate meter event does not solve or correct the requirement deficiency. Other corrective actions may be performed, such as prioritizing traffic associated with the network element over other traffic, providing additional bandwidth, providing additional memory usage, providing additional processing power or processor usage, changing one or more configurations with respect to the network element, and so forth. Embodiments are not limited in this manner and these and other details will become more apparent in the following description.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

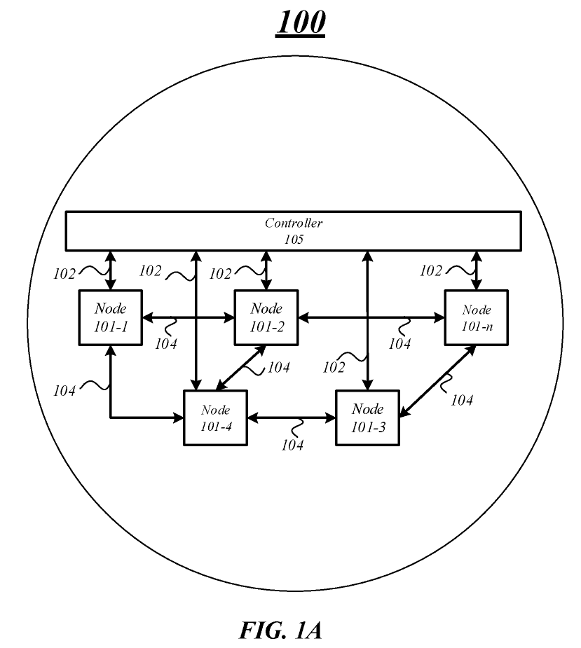

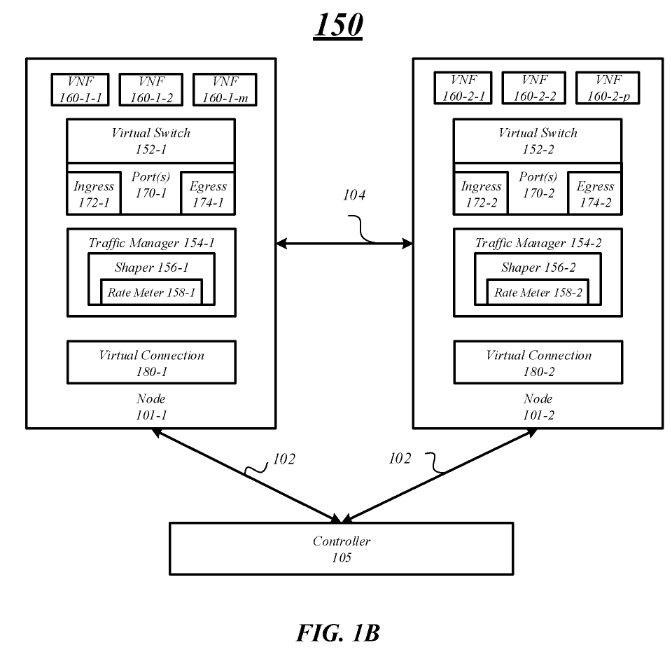

FIG. 1A illustrates a general overview of a networking environment 100 which may include a SDN environment. Generally, a SDN environment is a networking paradigm that breaks the vertical integration of traditional networking environments by separating the network's control logic from the data logic which may include routers and switches that forward traffic. Since the control logic is separated from the data logic, the control logic may be included in a centralized controller, such as controller 105 which may be a SDN controller. Further, the separation of the control logic and data logic also enables the controller 105 to manage traffic for nodes 101 which may implement virtual processing, and network elements such as virtual networking functions, virtual switches, virtual connections, traffic classes, and so forth. The separation of the control logic and the data logic may be realized by means of an application programming interface (API) to enable communication between the controller 105 and nodes 101, for example. In embodiments a centralized controller, such as controller 105, enables network service providers the ability to operate and adjust the SDN environment from a centralized software utility. Thus, embodiments may include detecting and determining when anomalies, e.g. when one or more requirements for services are not met in the network environment 100, and applying one or more corrective actions.

FIG. 1A illustrates a number of nodes 101-1 through 101-n, where n may be any positive integer, coupled via one or more networking connections 104. The networking connections 104 may be any type of wired and wireless networking connections 104 and may communicate traffic via any wired or wireless protocol such as Internet Protocol Version 4 (IPv4) and Version 6 (IPv6). Some embodiments may also include communicating traffic via the networking connections 104 utilizing standards such as OpenFlow®, which is an open standard protocol to enable communication in SDN environments. In some embodiments, the nodes 101 may also be coupled with the controller 105 via one or more links 102, which may be logical links to enable communication of traffic. Similarly, traffic communicated between the controller 105 and the nodes 101 may occur in accordance of one or more protocols, such as IPv4, IPv6, and OpenFlow®. In some instances, the link(s) 102 may be secure links that may use a form of data encryption to communicate information between the controller 105 and the nodes 101, for example. Further and in some instances, the links 102 may communicate information via the networking connections 104. Embodiments are not limited in this manner.

FIG. 1B illustrates an example of a system 150 for monitoring and detecting anomalies and deficient requirements in a networking environment, such as networking environment 100. The illustrated system 150 includes two nodes 101-1 and 101-2 and a controller 105 for illustrative purposes. Embodiments are not limited in this manner and may include any number of nodes 101-n, where n may be a positive integer. Further, some embodiments may include more than a single controller such that a number of nodes 101 are “centrally” controlled by different controllers. In other words, there may be different groups of nodes 101 each having a centralized controller.

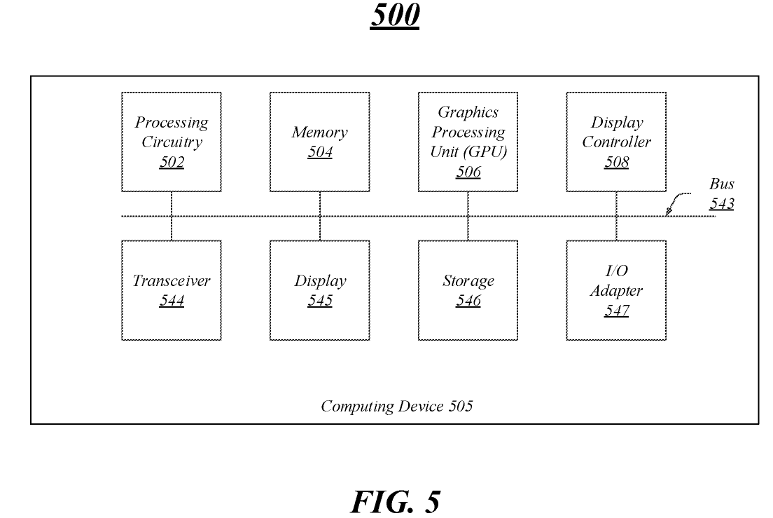

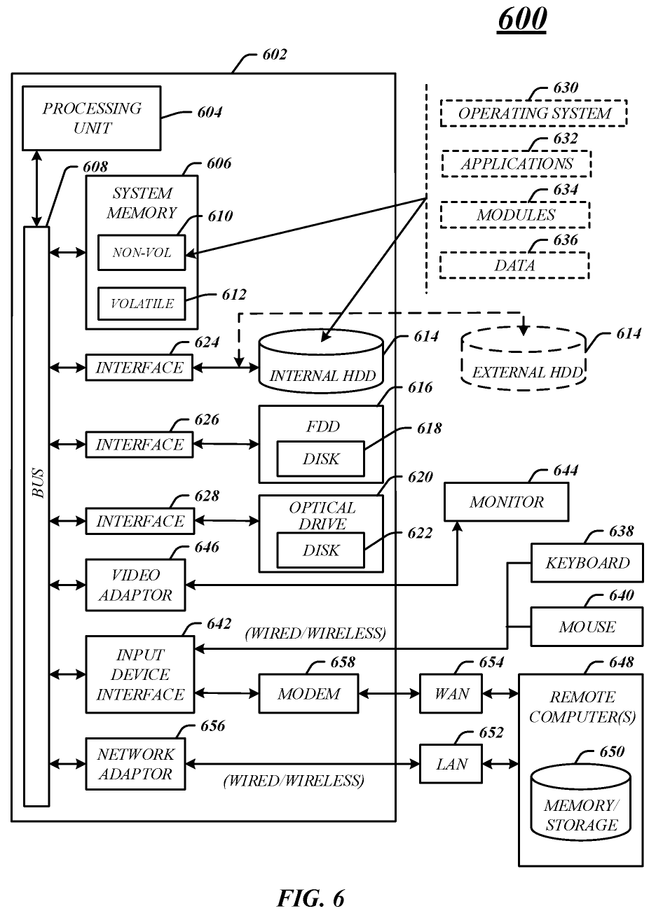

A node 101 may provide networking services and include networking elements, such as virtual networking functions (VNFs), virtual switches, virtual connections, and so forth. A node 101 may be a logical unit that is implemented on one or more devices, such as computing devices 500 and 600 illustrated in FIGS. 5 and 6, respectively. For example, one or more nodes 101 may be implemented on one or more standard physical servers, such as commercial off the shelf (COTs) servers. Moreover, components and elements of a node 101 may be implemented in processing circuitry, memory, storage, and so forth.

In embodiments, the first node 101-1 and the second node 101-2 may communicate information and traffic between each other. Further, each node 101-1 and 101-2 may communicate traffic with any other nodes 101. The traffic may include information for processing by a node 101 or another processing device. In some embodiments, each node 101 may operate as a networking device in the conventional sense. For example, a node 101 may operate as a switch, router, bridge, gateway, hub, repeater, and so forth.

In some instances, the nodes 101 may provide services and functionality via one or more VNFs 160 which may operate within one or more virtual machines (VMs) via virtual machine manger(s), such as hypervisor. These VNFs 160 may be responsible for handling specific networking functions and can be chained together to deliver full-scale networking communication services. For example, the VNFs 160 may provide services such as routing functionality, firewall capabilities, virtual Dynamic Host Control Protocol (vDHCP) capabilities, virtual Network Address Translation (vNAT) capabilities, virtual Universal Plug and Play (vUPnP), and so forth. The virtual nature of these VNFs 160 enables them to be dynamically scalable, relocatable, configurable, and can be flexibly deployable. These attributes are desirable and enable the VNFs 160 to be deployed in highly configurable manner to provide services for users.

In embodiments, one or more VNFs 160 may be deployed to provide services in accordance with specific requirements, such as one or more requirements stipulated in a service level agreement (SLA). These requirements may include bandwidth or throughput requirements, latency requirements, jitter requirements, mean time between failures (MTBF), mean time to recovery (MTTR), and so forth. Thus, embodiments may be directed towards monitoring systems to ensure these requirements are being met. If the requirements are not being met, the dynamic attributes of the VNFs 160 enable them to be relocated to a different node 101 which is capable of meeting the requirements, for example.

In embodiments, a node 101 may also include a virtual switch 152 that may be implemented in software, firmware, hardware, and a combination thereof. The virtual switch 152 can simulate a physical switch, such as an Ethernet switch. Thus, traffic communicated by the VNFs 160 and node 101 may be processed by the virtual switch 152. Further, the illustrated embodiment only shows one virtual switch 152 per node 101; however, embodiments are not limited in this manner. For example, a node 101 may include a number VMs having VNFs 160 each with a dedicated virtual switch 152. Moreover, the virtual switch 152 may include components not illustrated such as switching logic, a secure link interface, a flow table, and so forth. Further, the virtual switch 152 may include one or more ports 170 which may be virtual ports. The virtual switch 152 may communicate traffic between other nodes 101 via the one or more ports 170 over one or more virtual connections 180. Moreover, the virtual switch 152 including switching logic may forward network traffic between the ports 170 as flows defined by the controller 105. In embodiments, each of the ports 170 may include an ingress port 172 to receive traffic and egress port 174 to send traffic.

In embodiments, the traffic communicated by the virtual switch 152 may be processed and monitored by a traffic manger 154 which may include among other components a traffic shaper 156. The traffic shaper 156 is capable of controlling the communication of traffic from various VNFs 160, for example. The traffic shaper 156 may delay certain packets with respect to other packets to bring them in compliance with a desired traffic profile and specified requirements. The traffic shaper 156 may also be used to optimize or guarantee performance, improve latency, and/or increase usable bandwidth. A traffic shaper 156 may provide this functionality via rate limiters and other components.

In embodiments, the traffic shaper 156 may include one or more rate meters 158 set to monitor traffic to ensure that the specified requirements for services are being met. In some instances, a rate meter 158 may monitor the egress port 174 of a virtual switch 152 to determine an instantaneous and/or average throughput. For example, a rate meter 158 may be set to detect anomalies or deficient requirements, such as throughput being greater than, less than or equal to a threshold value. The threshold value may be user or computer configured and based on the requirements of a SLA. Examples of detecting anomalies may include determining if an instantaneous throughput is greater than (or equal to) an instantaneous maximum threshold value, an instantaneous throughput is less than (or equal to) an instantaneous minimum threshold value, an average throughput is greater than (or equal to) an average maximum threshold value, or an average throughput is less than (or equal to) an average minimum threshold value. If an anomaly is detected, the rate meter 158 may trigger a rate meter event. Thus, a rate meter 158 may detect an anomaly and communicate rate meter information to the controller 105, which may perform a corrective action.

In some embodiments, a rate meter 158 may be set based on a timer to periodically, semi-periodically, or non-periodically communicate rate meter information including a throughput (average or instantaneous) to the controller 105. In another words, the rate meter 158 may be time based and not dependent on the detection of throughput being higher or lower than a threshold value. The time for the timer may be configured by a user or computer generated and may be based on the SLA, for example. The rate meter information may be used by the controller 105 to make real-time adjustments, if necessary, to ensure SLAs are being met for workloads.

In the illustrated embodiment, only one rate meter 158 is shown for each node 101. However, embodiments are not limited in this manner. A node 101 may include any number of rate meters 158 to monitor various traffic classes and network elements. For example, each VNF 160 may have a rate meter 158 set to monitor traffic for the specific VNF 160. Further, a rate meter 158 may be set to monitor a virtual connection 180. Note that a node 101 may include multiple virtual connections 180, each which may be dedicated to particular VNFs 160 and each may include a rate meter 158. Thus, a rate meter 158 may operate as a fined grain monitor for network elements. Further, a rate meter 158 is virtualization aware in the sense that it can be defined per a VNF 160 as well as per a physical network card (PNIC) interface, per virtual connection 180 (virtual local area network (VLAN), Virtual Extensible LAN (VXLAN), QinQ, and so forth), per tunnel GRE, per traffic class, and so forth.

As previously mentioned, a rate meter 158 may be set to determine whether an instantaneous and/or average throughput is greater than, less than, or equal to a throughput threshold value and trigger a rate meter event based on the determination. The rate meter 158 may determine throughput for a network element or traffic class by monitoring traffic through an egress port 174. The traffic (e.g. packets) may be associated with a network element and/or traffic class which can be determined by identification information in the traffic. For example, a header in packets of the traffic may include identification information indicating a traffic class and an associated (sending) network element. Embodiments are not limited in this manner and a rate meter 158 may monitor traffic for network elements and traffic classes utilizing other identification techniques.

In some embodiments, different rate meters 158 may have different settings. For example, one rate meter 158 may be set to trigger or cause a rate meter event when throughput is above a particular throughput threshold. In the same example, a different rate meter 158 may be set to trigger or cause a rate meter event when throughput is above a different throughput threshold. In another example, a rate meter 158 may be set to cause a rate meter event when throughput is below a throughput threshold. Moreover, a rate meter 158 may be configured or set to ensure throughput is between a minimum threshold value and a maximum threshold value. Thus, the same rate meter 158 may cause a rate meter event when throughput is above a maximum threshold value or below a minimum threshold value.

In embodiments, a rate meter 158 may cause rate meter information to be communicated to the controller 105. The rate meter information may include an indication that a rate meter event occurred. For example, the rate meter information may include identification for the affected network element and/or traffic class, and a value indicating an extent to which throughput is above or below (or equal) a threshold value. However, embodiments are not limited in this manner and the rate meter information may include other information, such as history information indicating whether the specific rate meter has previously triggered an event and a number of times of occurrence. The rate meter information may also indicate the measured throughput that caused the rate meter event to trigger. In response to receiving the rate meter information, the controller 105 may perform one or more corrective actions, as will be discussed in more detail below.

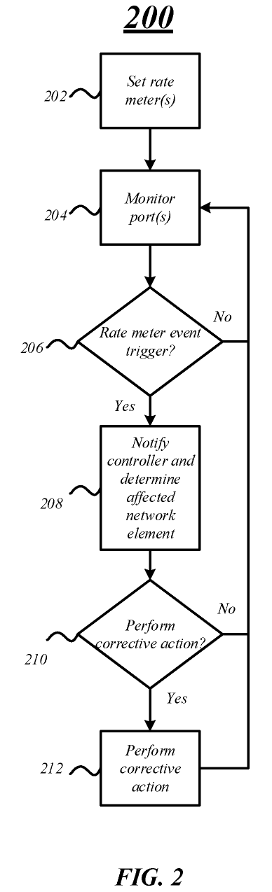

FIG. 2 illustrates an example of a first logic flow 200 for processing in a networking environment, such as an SDN networking environment. The logic flow 200 may be representative of some or all of the operations executed by one or more embodiments described herein.

At block 202, embodiments may include setting one or more rate meters to monitor network elements or traffic class. The rate meter(s) may be set for a network element or traffic class based on requirements specified in an SLA. For example, a rate meter may be set to monitor throughput for a network element and cause a rate meter event to trigger if the throughput (average or instantaneous) is above, below, or equal to a threshold throughput value (average or instantaneous). The threshold throughput value may be based on the requirements and SLA and ensure that throughput for the monitored network element or traffic class is meeting those requirements. Embodiments are not limited in this manner.

At block 204, the one or more rate meters may monitor egress ports to determine whether throughput for the associated network element or traffic class is meeting the specified requirements. At decision block 206, a determination may be made as whether a rate meter event triggered. As previously discussed, a rate meter event may be triggered by a rate meter if throughput (average or instantaneous) is above, below, or equal to the set throughput threshold value for the rate meter. If a rate meter event has not triggered, the logic flow 200 may include continuing to monitor for a rate meter event to trigger.

If a rate meter event triggered at block 206, embodiments may include communicating rate meter information to a controller and determining the affected network element or traffic class based on which rate meter event triggered or identification information at block 208. For example, a rate meter set to monitor throughput for a VNF may include an indication or identification for the VNF when the rate meter event triggers. Similarly, a traffic class may also be identified if a rate meter event triggers for the traffic class. For example, the rate meter information communicated to a controller may include identification information identifying affected network elements and/or traffic classes. Embodiments are not limited in this manner. In some instances the determination may be based merely on which of the rate meters set triggered.

At block 210, a determination as to whether to perform a corrective action based on the triggered rate meter event may be made. For example, a controller may determine whether the triggered rate meter event requires a corrective action based on the requirements and SLA of a workload utilizing the affected network elements or traffic classes. For example, the requirements and SLA may permit a minimum number of rate meter events to trigger for a network element or traffic class before a corrective action must be taken. A corrective action may be taken if the minimum number of rate meter events has be reached or surpassed. In another example, the requirements and SLA may not permit any rate meter events; and therefore require a corrective action to be performed when the first rate meter event is triggered. Embodiments are not limited to these examples. If no corrective action is to be performed, the flow 200 may include continuing to monitor the egress port until another rate meter event is triggered.

If a corrective action is to be performed at block 210, the controller may cause the corrective action at block 212. The corrective action may include migrating the associated network element from its current node to a different node. This may include moving the network element from operation on a particular device to another device. The devices may be processors or computing devices, such as servers. In another example, the corrective action may include migrating a different network element, not associated with the rate meter event to a different node. The network element associated with rate meter event may remain within or on its' current node. Embodiments are not limited in this manner and other corrective actions may be performed. For example, traffic for the network element associated with the rate meter event may be prioritized over other traffic, e.g. reconfigure a network element.

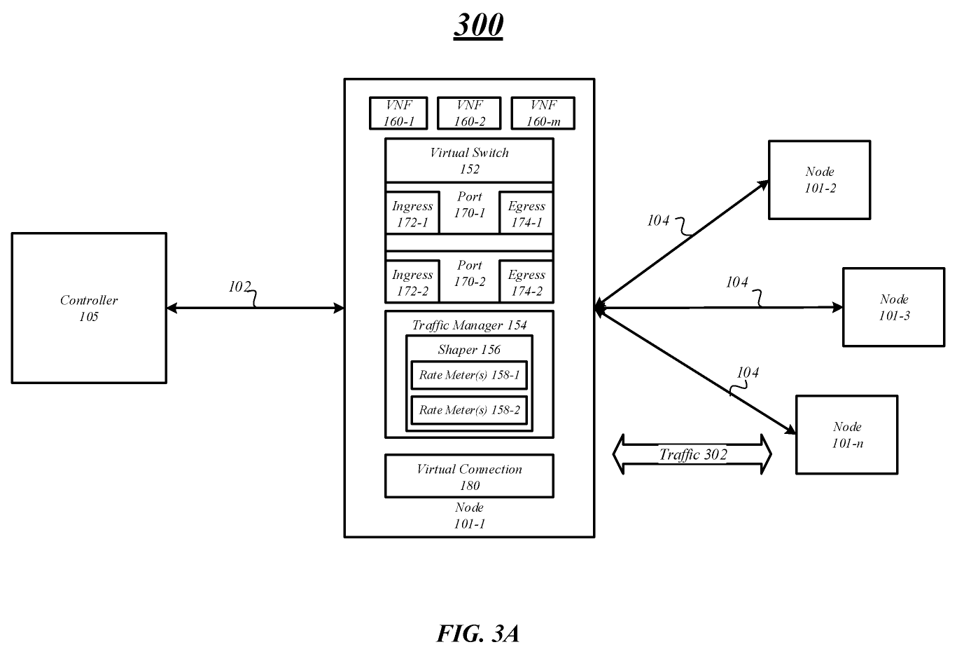

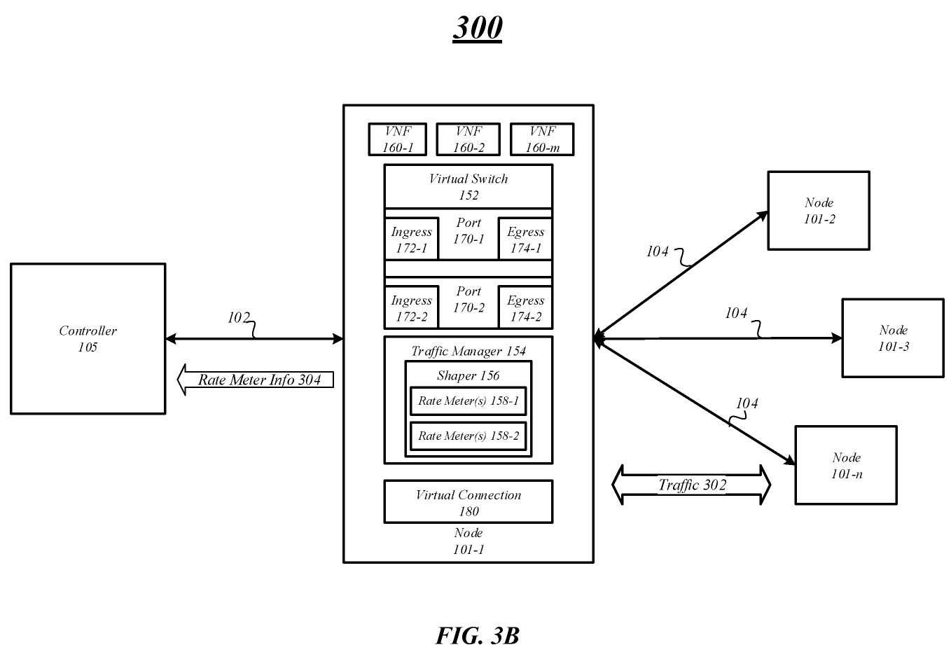

FIGS. 3A/3B illustrate an example of a system 300 for communicating traffic 302 between nodes in a SDN environment and monitoring throughput via rate meters 158. In the illustrated example, a node 101-1 may be coupled with other nodes 101-2 through 101-n, where n may be any positive integer, via one or more network connections 104. The networking connections 104 may be wired or wireless networking connections and are capable of communicating traffic 302 via one or more protocols, as previously discussed.

In some embodiments, one or more of the nodes 101 may include network elements, such as VNFs 160, virtual switches 152, virtual connections 180, and so forth to communicate traffic 302 between the other nodes 101. For example, the node 101-1 may communicate traffic 302 with any one of the nodes 101-2 through 101-n that is processed by one or more VNFs 160-1, 160-2, and 160-m, where m may be any positive integer. The traffic 302 may be communicated through and routed by the virtual switch 152 to the appropriate egress port 174 for communication over the virtual connection 180 to another node 101. As previously mentioned, a virtual switch 152 may include any number of ports 170. For example, FIGS. 3A and 3B illustrate the virtual switching 152 have a first port 170-1 having an ingress port 172-1 and an egress port 174-1, and a second port 170-2 having an ingress port 172-2 and an egress port 174-2. However, embodiments are not limited to the virtual switch 152 having only two ports 170, the virtual switch 152 may have any number of ports 170. Further, the virtual switch 152 may also include switching logic to determine which port 170 to communicate the traffic 302. In some embodiments, the determination may be based on information in the traffic 302 itself, such as a sending address, a destination address, and other identifiers.

The node 101-1 may also include a traffic manager 154 including a traffic shaper 156 (and other components such as a classifier), that may control and process traffic 302 to be communicated via the virtual switch 152 and port(s) 170. In some embodiments, the traffic shaper 156 may have one or more rate meter(s) 158 to monitor traffic 302 communicated via the ingress ports 172 and the egress ports 174. In some embodiments, a rate meter 158 may be set to monitor traffic 302 associated with a particular traffic class or networking element. For example, a first VNF 160-1 may be configured to provide a service, such as routing capabilities, for a user or system in accordance with requirements and a SLA. A first rate meter 158-1 may be associated or set for the VNF 160-1 to monitor traffic 302 communicated via a first egress port 174-1. As previously discussed, the first rate meter 158-1 may be set to cause a rate meter event when throughput is above, below, and/or equal to a threshold throughput value (average or instantaneous) at the first egress port 174-1. The threshold throughput value may be based on or defined in the requirements and a SLA. If the rate meter event is triggered, the node 101-1 may communicate rate meter information 304 to a controller 105 via a link 102, as illustrated in FIG. 3B. The link 102 may include wired and wireless communication links and communicate information via an API. The controller 105 may cause a corrective action to occur, if necessary, based on the reception of the rate meter information 304, the triggered rate meter event, and the affected networking elements and traffic classes.

In another example, a second VNF 160-2 may communicate information via a second port 170-2 including ingress port 172-2 and egress port 174-2. The second VNF 160-2 may also provide a service, such as firewall capabilities, for the same or different user or system. Further, a second rate meter 158-2 may be set on the second VNF 160-2 to monitor the egress port 174-2 for the second VNF 160-2 and ensure requirements and a SLA are being met. Note that the requirements for the second VNF 160-2 may be different than the requirement for the first VNF 160-1. Thus, the second rate meter 158-2 may be set to occur or trigger based at a different throughput threshold value (or a range of values). If the second rate meter 158-2 triggers, the node 101-1 may also communicate rate meter information 304 to the controller 105. The controller 105 may cause one or more corrective actions to occur, if necessary, for the second VNF 160-2. Embodiments are not limited to these examples.

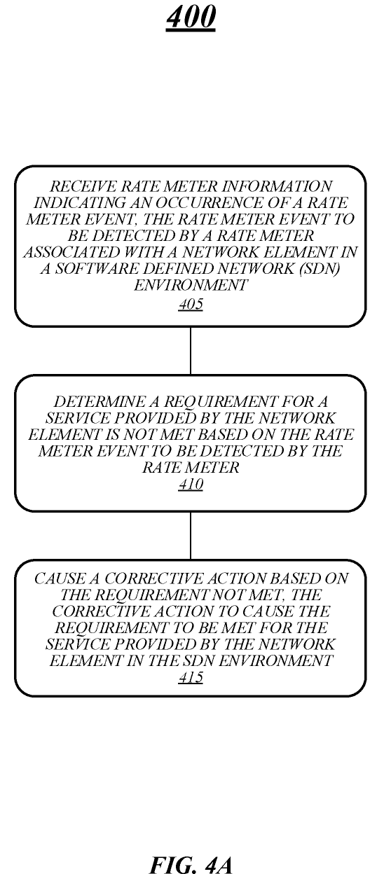

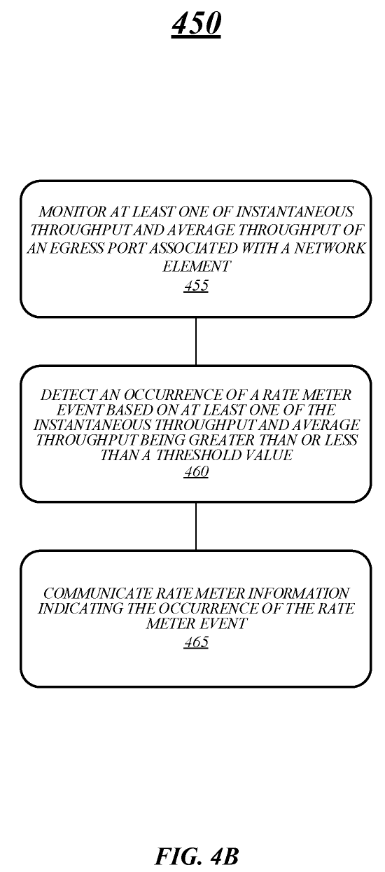

FIG. 4A illustrates an example of a second logic flow diagram 400. The logic flow 400 may be representative of some or all of the operations executed by one or more embodiments described herein. For example, the logic flow 400 may illustrate operations performed by one or more systems or nodes in FIGS. 1A/1B and 3A/3B including controller 105. Various embodiments are not limited in this manner.

In various embodiments, logic flow 400 may include receiving rate meter information indicating an occurrence of a rate meter event, the rate meter event determined by a rate meter associated with a network element in a software defined network (SDN) environment. As previously discussed, the rate meter may be set on a network element to monitor an egress port associated with the network element. The rate meter may trigger causing a rate meter event when a throughput value is greater than, less than or equal to a set throughput threshold value. The throughput threshold value may be set to a value or based on a value specified as a requirement in a SLA, for example. More specifically, the throughput threshold value may be set to ensure traffic associated with the network element is greater than (or equal) to a minimum throughput value, less than (or equal) to a maximum threshold value, or within a range of throughput threshold values. The throughput may be determined by the rate meter and may be the average throughput over a period of time or the instantaneous throughput at a point in time. Embodiments are not limited in this manner.

At block 410, the logic flow 400 may include determine a requirement for a service provided by the network element is not met based on the rate meter event detected by the rate meter. As previously mentioned, the requirement may include when one or more of the throughput threshold values are exceeded or not being met by an egress port of a virtual switch. For example, a requirement may not be met when throughput is below (or equal) a minimum throughput threshold value. In another example, a requirement may not be met when the throughput is above (or equal) a maximum throughput threshold value. A requirement not being met may indicate an anomaly in the system or that the system is not properly configured, which may require corrective action.

At block 415, the logic flow 400 includes causing a corrective action based on the requirement not met, the corrective action to cause the requirement to be met for the service provided by the network element in the SDN environment. For example, embodiments may include determining to perform the corrective action which may include one or more of migrating the network element from a first node to another node, migrating a different network element from the first node to another node, and reconfiguring a network element. In embodiments, the logic may include moving the network element associated with the rate meter event to a different node when the current node cannot met the requirement. In another example, the logic may include moving another network element on the same node as the network element associated with the rate meter event to another node. This may occur when moving the network element associated with the rate meter event does not solve or correct the requirement deficiency. Other corrective actions may be performed, such as prioritizing traffic associated with the network element over other traffic, providing additional bandwidth, providing additional memory usage, providing additional processing power, changing one or more configurations with respect to the network element, and so forth. Embodiments are not limited in this manner.

FIG. 4B illustrates an example of a second logic flow diagram 450. The logic flow 450 may be representative of some or all of the operations executed by one or more embodiments described herein. For example, the logic flow 450 may illustrate operations performed by one or more systems or nodes in FIGS. 1A/1B and 3A/3B including a traffic manager and a rate meter. Various embodiments are not limited in this manner.

At block 455, the logic flow 450 includes monitoring at least one of instantaneous throughput and average throughput of an egress port associated with a network element. For example, a networking element such as a VNF, virtual switch, virtual connection, traffic class, and so forth may have a rate meter set to passively monitor an egress port to ensure that one or more requirements for the network element are being met. The rate meter may measure the outgoing throughput traffic to ensure that a minimum rate, a maximum rate, or both are being met for the network element.

In some embodiments, the logic flow 450 includes detecting an occurrence of a rate meter event based on at least one of the instantaneous throughput and average throughput being greater than, less than, or equal to a threshold value at block 460. In some embodiments a rate meter may trigger or cause the rate meter event when the threshold value is not being met, as previously discussed, and be based on a periodic reporting requirement. Further and at block 465, the logic flow 450 includes sending rate meter information indicating the occurrence of the rate meter event. The rate meter information may be sent from the rate meter, e.g. traffic manager, to a controller or SDN controller via an API, for example. The controller may cause a corrective action to occur based on the rate meter information. Embodiments are not limited in this manner.

FIG. 5 illustrates one embodiment of a system 500. In various embodiments, system 500 may be representative of a system or architecture suitable for use with one or more embodiments described herein, such as systems and devices illustrated in FIGS. 1A, 1B, 3A, and 3B. The embodiments are not limited in this respect.

As shown in FIG. 5, system 500 may include multiple elements. One or more elements may be implemented using one or more circuits, components, registers, processors, software subroutines, modules, or any combination thereof, as desired for a given set of design or performance constraints. Although FIG. 5 shows a limited number of elements in a certain topology by way of example, it can be appreciated that more or less elements in any suitable topology may be used in system 500 as desired for a given implementation. The embodiments are not limited in this context.

In various embodiments, system 500 may include a computing device 505 which may be any type of computer or processing device including a personal computer, desktop computer, tablet computer, netbook computer, notebook computer, laptop computer, server, server farm, blade server, or any other type of server, and so forth.

In various embodiments, computing device 505 may include processor circuit 502. Processor circuit 502 may be implemented using any processor or logic device. The processing circuit 502 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing circuit 502 may be connected to and communicate with the other elements of the computing system via an interconnect 543, such as one or more buses, control lines, and data lines.

In one embodiment, computing device 505 may include a memory unit 504 to couple to processor circuit 502. Memory unit 504 may be coupled to processor circuit 502 via communications bus 543, or by a dedicated communications bus between processor circuit 502 and memory unit 504, as desired for a given implementation. Memory unit 504 may be implemented using any machine-readable or computer-readable media capable of storing data, including both volatile and non-volatile memory. In some embodiments, the machine-readable or computer-readable medium may include a non-transitory medium. The embodiments are not limited in this context. In some embodiments, memory 108 may be the same as memory unit 504.

Computing device 505 may include a graphics processing unit (GPU) 506, in various embodiments. The GPU 506 may include any processing unit, logic or circuitry optimized to perform graphics-related operations as well as the video decoder engines and the frame correlation engines. The GPU 506 may be used to render 2-dimensional (2-D) and/or 3-dimensional (3-D) images for various applications such as video games, graphics, computer-aided design (CAD), simulation and visualization tools, imaging, etc. Various embodiments are not limited in this manner; GPU 506 may process any type of graphics data such as pictures, videos, programs, animation, 3D, 2D, objects images and so forth.

In some embodiments, computing device 505 may include a display controller 508. Display controller 508 may be any type of processor, controller, circuit, logic, and so forth for processing graphics information and displaying the graphics information. The display controller 508 may receive or retrieve graphics information from one or more buffers. After processing the information, the display controller 508 may send the graphics information to a display.

In various embodiments, system 500 may include a transceiver 544. Transceiver 544 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. It may also include a transceiver for wired networking which may include (but are not limited to) Ethernet, Packet Optical Networks, (data center) network fabric, etc. In communicating across such networks, transceiver 544 may operate in accordance with one or more applicable standards in any version. The embodiments are not limited in this context.

In various embodiments, computing device 505 may include a display 545. Display 545 may constitute any display device capable of displaying information received from processor circuit 502, graphics processing unit 506 and display controller 508.

In various embodiments, computing device 505 may include storage 546. Storage 546 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 546 may include technology to increase the storage performance enhanced protection for valuable digital media when multiple hard drives are included, for example. Further examples of storage 546 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, computing device 505 may include one or more I/O adapters 547. Examples of I/O adapters 547 may include Universal Serial Bus (USB) ports/adapters, IEEE 1394 Firewire ports/adapters, and so forth. The embodiments are not limited in this context.

FIG. 6 illustrates an embodiment of an exemplary computing architecture 600 suitable for implementing various embodiments as previously described. In one embodiment, the computing architecture 600 may comprise or be implemented as part one or more systems and devices previously discussed.

As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, such as those described with reference to the processing circuitry.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 600 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of the system 105.

A user can enter commands and information into the computer 602 through one or more wired/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wired and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wired/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements and components as previously described with reference to FIGS. 1-5 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirty-three (1-33) provided below are intended to be exemplary and non-limiting.

In a first example, a system, device, apparatus may include memory, processing circuitry coupled with the memory, and logic, at least partially implemented by the processing circuitry. The logic to receive rate meter information indicating an occurrence of a rate meter event, the rate meter event to be detected by a rate meter associated with a network element in a software defined network (SDN) environment, determine a requirement for a service provided by the network element is not met based on the rate meter event to be detected by the rate meter, and cause a corrective action based on the requirement not met, the corrective action to cause the requirement to be met for the service provided by the network element in the SDN environment.

In a second example and in furtherance of the first example, a system, device, apparatus may include the network element comprising at least one of a virtual network function, a virtual connection, a virtual switch, and a traffic class, and the service comprising at least one of a routing functionality, a firewall capability, a virtual Dynamic Host Control Protocol (vDHCP) capability, a virtual Network Address Translation (vNAT) capability, and a virtual Universal Plug and Play (vUPnP).

In a third example and in furtherance of any previous example, a system, device, apparatus may include the corrective action comprising at least one of migrating the network element from a first node to another node, migrating a different network element from the first node to another node, and reconfiguring a network element.

In a fourth example and in furtherance of any previous example, a system, device, apparatus may include the requirement determined to not be met based on at least one of an instantaneous throughput being greater than an instantaneous maximum threshold value, an instantaneous throughput being less than an instantaneous minimum threshold value, an average throughput being greater than an average maximum threshold value, and an average throughput being less than an average minimum threshold value.

In a fifth example and in furtherance of any previous example, a system, device, apparatus may include the rate meter set to monitor instantaneous throughput of an egress port in the SDN environment, and cause the rate meter event if the instantaneous throughput is greater than an instantaneous maximum threshold value or the instantaneous throughput is less than an instantaneous minimum threshold value.

In a sixth example and in furtherance of any previous example, a system, device, apparatus may include the rate meter set to monitor average throughput of the egress port, and cause the rate meter event if the average throughput is greater than a maximum average threshold value or the average throughput is less than a minimum average throughput.

In a seventh example and in furtherance of any previous example, a system, device, apparatus may include the requirement comprising a service level agreement requirement and the rate meter set based on a service level agreement requirement for the network element, the service level agreement requirement to ensure at least one of a minimum throughput and a maximum throughput are maintained for the network element.

In an eighth example and in furtherance of any previous example, a system, device, apparatus may include the logic to enable a user or a device to set one or more rate meters in a traffic manager, each of the one or more rate meters to monitor at least one network element.

In a ninth example and in furtherance of any previous example, a system, device, apparatus may include a SDN controller including the memory and the processing circuitry, the SDN controller to receive the rate meter information through an application programming interface (API).

In a tenth example and in furtherance of any previous example, embodiments may include a computer-readable storage medium comprising a plurality of instructions that, when executed by processing circuitry, enable processing circuitry to receive rate meter information indicating an occurrence of a rate meter event, the rate meter event to be determined by a rate meter associated with a network element in a software defined network (SDN) environment, determine a requirement for a service provided by the network element is not met based on the rate meter event to be detected by the rate meter, and cause a corrective action based on the requirement not met, the corrective action to cause the requirement to be met for the service provided by the network element in the SDN environment.

In a eleven example and in furtherance of any previous example, embodiments may include a plurality of instructions to process the network element comprising at least one of a virtual network function, a virtual connection, virtual switch, and a traffic class, and the service comprising at least one of a routing functionality, a firewall capability, a virtual Dynamic Host Control Protocol (vDHCP) capability, a virtual Network Address Translation (vNAT) capability, and a virtual Universal Plug and Play (vUPnP).

In a twelve example and in furtherance of any previous example, embodiments may include a plurality of instructions to cause the corrective action comprising at least one of migrating the network element from a first node to another node, migrating a different network element from the first node to another node, and reconfiguring a network element.

In a thirteenth example and in furtherance of any previous example, embodiments may include a plurality of instructions to determine the requirement determined is not met based on at least one of an instantaneous throughput being greater than an instantaneous maximum threshold value, an instantaneous throughput being less than an instantaneous minimum threshold value, an average throughput being greater than an average maximum threshold value, and an average throughput being less than an average minimum threshold value.

In a fourteenth example and in furtherance of any previous example, embodiments may include a plurality of instructions to process the rate meter set to monitor instantaneous throughput of an egress port in the SDN environment, and to cause the rate meter event if the instantaneous throughput is greater than or equal to an instantaneous maximum threshold value or the instantaneous throughput is less than or equal to an instantaneous minimum threshold value.

In a fifteenth example and in furtherance of any previous example, embodiments may include a plurality of instructions to process the rate meter set to monitor average throughput of the egress port, and to cause the rate meter event if the average throughput is greater than or equal to a maximum average threshold value or the average throughput is less than or equal to a minimum average throughput.

In a sixteenth example and in furtherance of any previous example, embodiments may include a plurality of instructions to process the requirement comprising a service level agreement requirement and the rate meter set based on a service level agreement requirement for the network element, the service level agreement requirement to ensure at least one of a minimum throughput and a maximum throughput are maintained for the network element.

In a seventeenth example and in furtherance of any previous example, embodiments may include a plurality of instructions to enable a user to set one or more rate meters in a traffic manager, each of the one or more meters to monitor at least one network element.

In an eighteenth example and in furtherance of any previous example, embodiments may include a method including receiving rate meter information indicating an occurrence of a rate meter event, the rate meter event to be determined by a rate meter associated with a network element in a software defined network (SDN) environment, determining a requirement for a service provided by the network element is not met based on the rate meter event to be detected by the rate meter, and causing a corrective action based on the requirement not met, the corrective action to cause the requirement to be met for the service provided by the network element in the SDN environment.

In a nineteenth example and in furtherance of any previous example, embodiments may include a method for processing the network element comprising at least one of a virtual network function, a virtual connection, virtual switch, and a traffic class, and the service comprising at least one of a routing functionality, a firewall capability, a virtual Dynamic Host Control Protocol (vDHCP) capability, a virtual Network Address Translation (vNAT) capability, and a virtual Universal Plug and Play (vUPnP).

In a twentieth example and in furtherance of any previous example, embodiments may include a method including causing the corrective action comprising at least one of migrating the network element from a first node to another node, migrating a different network element from the first node to another node, and reconfiguring a network element.

In a twenty-first example and in furtherance of any previous example, embodiments may include a method including determining the requirement not to be met based on at least one of an instantaneous throughput being greater than an instantaneous maximum threshold value, an instantaneous throughput being less than an instantaneous minimum threshold value, an average throughput being greater than an average maximum threshold value, and an average throughput being less than an average minimum threshold value

In a twenty-second example and in furtherance of any previous example, embodiments may include a method for processing the rate meter set to monitor instantaneous throughput of an egress port in the SDN environment, and to cause the rate meter event if at least one of the instantaneous throughput is greater than an instantaneous maximum threshold value and the instantaneous throughput is less than an instantaneous minimum threshold value.

In a twenty-third example and in furtherance of any previous example, embodiments may include a method for processing the rate meter set to monitor average throughput of the egress port, and to cause the rate meter event if at least one of the average throughput is greater than a maximum average threshold value and the average throughput is less than a minimum average throughput.

In a twenty-fourth example and in furtherance of any previous example, embodiments may include a method for processing the requirement comprising a service level agreement requirement and the rate meter set based on a service level agreement requirement for the network element, the service level agreement requirement to ensure at least one of a minimum throughput and a maximum throughput are maintained for the network element.

In a twenty-fifth example and in furtherance of any previous example, embodiments may include a method including enabling a user to set one or more rate meters in a traffic manager, each of the one or more meters to monitor at least one network element.

In a twenty-sixth example and in furtherance of any previous example, embodiments may include an apparatus having means for receiving rate meter information indicating an occurrence of a rate meter event, the rate meter event to be determined by a rate meter associated with a network element in a software defined network (SDN) environment, means for determining a requirement for a service provided by the network element is not met based on the rate meter event to be detected by the rate meter, an means for causing a corrective action based on the requirement not met, the corrective action to cause the requirement to be met for the service provided by the network element in the SDN environment.

In a twenty-seventh example and in furtherance of any previous example, embodiments may include means for processing the network element comprising at least one of a virtual network function, a virtual connection, virtual switch, and a traffic class, and the service comprising at least one of a routing functionality, a firewall capability, a virtual Dynamic Host Control Protocol (vDHCP) capability, a virtual Network Address Translation (vNAT) capability, and a virtual Universal Plug and Play (vUPnP).

In a twenty-eighth example and in furtherance of any previous example, embodiments may include an apparatus having means for causing the corrective action comprising at least one of migrating the network element from a first node to another node, migrating a different network element from the first node to another node, and reconfiguring a network element.

In a twenty-ninth example and in furtherance of any previous example, embodiments may include an apparatus having means for determining the requirement determined is not met based on at least one of an instantaneous throughput being greater than an instantaneous maximum threshold value, an instantaneous throughput being less than an instantaneous minimum threshold value, an average throughput being greater than an average maximum threshold value, and an average throughput being less than an average minimum threshold value.

In a thirtieth example and in furtherance of any previous example, embodiments may include an apparatus having means for processing the rate meter set to monitor instantaneous throughput of an egress port in the SDN environment, and the apparatus comprising means for causing the rate meter event if the instantaneous throughput is greater than or equal to an instantaneous maximum threshold value or the instantaneous throughput is less than or equal to an instantaneous minimum threshold value.

In a thirty-first example and in furtherance of any previous example, embodiments may include an apparatus having means for processing the rate meter set to monitor average throughput of the egress port, and to cause the rate meter event if the average throughput is greater than or equal to a maximum average threshold value or the average throughput is less than or equal to a minimum average throughput.

In a thirty-second example and in furtherance of any previous example, embodiments may include an apparatus having means for processing the requirement comprising a service level agreement requirement and the rate meter set based on a service level agreement requirement for the network element, the service level agreement requirement to ensure at least one of a minimum throughput and a maximum throughput are maintained for the network element.

In a thirty-third example and in furtherance of any previous example, embodiments may include an apparatus having means for enabling a user to set one or more rate meters in a traffic manager, each of the one or more meters to monitor at least one network element.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
memory;
processing circuitry coupled with the memory; and
logic, at least partially implemented by the processing circuitry, the logic to:
receive rate meter information indicating an occurrence of a rate meter event, the rate meter event to be detected by a rate meter associated with a network element in a software defined network (SDN) environment;
determine a requirement for a service provided by the network element is not met based on the rate meter event to be detected by the rate meter; and
cause a corrective action based on the requirement not met, the corrective action to cause the requirement to be met for the service provided by the network element in the SDN environment.

2. The apparatus of claim 1, the network element comprising at least one of a virtual network function, a virtual connection, a virtual switch, and a traffic class, and the service comprising at least one of a routing functionality, a firewall capability, a virtual Dynamic Host Control Protocol (vDHCP) capability, a virtual Network Address Translation (vNAT) capability, and a virtual Universal Plug and Play (vUPnP).

3. The apparatus of claim 1, the corrective action comprising at least one of migrating the network element from a first node to another node, migrating a different network element from the first node to another node, and reconfiguring a network element.

4. The apparatus of claim 1, the requirement determined to not be met based on at least one of an instantaneous throughput being greater than an instantaneous maximum threshold value, an instantaneous throughput being less than an instantaneous minimum threshold value, an average throughput being greater than an average maximum threshold value, and an average throughput being less than an average minimum threshold value.

5. The apparatus of claim 1, the rate meter set to monitor instantaneous throughput of an egress port in the SDN environment, and cause the rate meter event if the instantaneous throughput is greater than an instantaneous maximum threshold value or the instantaneous throughput is less than an instantaneous minimum threshold value.

6. The apparatus of claim 5, the rate meter set to monitor average throughput of the egress port, and cause the rate meter event if the average throughput is greater than a maximum average threshold value or the average throughput is less than a minimum average throughput.

7. The apparatus of claim 1, the requirement comprising a service level agreement requirement and the rate meter set based on a service level agreement requirement for the network element, the service level agreement requirement to ensure at least one of a minimum throughput and a maximum throughput are maintained for the network element.

8. The apparatus of claim 1, the logic to enable a user or a device to set one or more rate meters in a traffic manager, each of the one or more rate meters to monitor at least one network element.

9. The apparatus of claim 1, comprising a SDN controller including the memory and the processing circuitry, the SDN controller to receive the rate meter information through an application programming interface (API).

10. A computer-readable storage medium comprising a plurality of instructions that, when executed by processing circuitry, enable processing circuitry to:
receive rate meter information indicating an occurrence of a rate meter event, the rate meter event to be determined by a rate meter associated with a network element in a software defined network (SDN) environment;
determine a requirement for a service provided by the network element is not met based on the rate meter event to be detected by the rate meter; and
cause a corrective action based on the requirement not met, the corrective action to cause the requirement to be met for the service provided by the network element in the SDN environment.

11. The computer-readable storage medium of claim 10, the network element comprising at least one of a virtual network function, a virtual connection, virtual switch, and a traffic class, and the service comprising at least one of a routing functionality, a firewall capability, a virtual Dynamic Host Control Protocol (vDHCP) capability, a virtual Network Address Translation (vNAT) capability, and a virtual Universal Plug and Play (vUPnP).

12. The computer-readable storage medium of claim 10, comprising a plurality of instructions, that when executed, enable processing circuitry to cause the corrective action comprising at least one of migrating the network element from a first node to another node, migrating a different network element from the first node to another node, and reconfiguring a network element.

13. The computer-readable storage medium of claim 10, comprising a plurality of instructions, that when executed, enable processing circuitry to determine the requirement determined is not met based on at least one of an instantaneous throughput being greater than an instantaneous maximum threshold value, an instantaneous throughput being less than an instantaneous minimum threshold value, an average throughput being greater than an average maximum threshold value, and an average throughput being less than an average minimum threshold value.

14. The computer-readable storage medium of claim 10, the rate meter set to monitor instantaneous throughput of an egress port in the SDN environment, and to cause the rate meter event if the instantaneous throughput is greater than or equal to an instantaneous maximum threshold value or the instantaneous throughput is less than or equal to an instantaneous minimum threshold value.

15. The computer-readable storage medium of claim 14, the rate meter set to monitor average throughput of the egress port, and to cause the rate meter event if the average throughput is greater than or equal to a maximum average threshold value or the average throughput is less than or equal to a minimum average throughput.

16. The computer-readable storage medium of claim 10, the requirement comprising a service level agreement requirement and the rate meter set based on a service level agreement requirement for the network element, the service level agreement requirement to ensure at least one of a minimum throughput and a maximum throughput are maintained for the network element.

17. The computer-readable storage medium of claim 10, comprising a plurality of instructions, that when executed, enable processing circuitry to enable a user to set one or more rate meters in a traffic manager, each of the one or more meters to monitor at least one network element.

18. A computer-implemented method, comprising:
receiving rate meter information indicating an occurrence of a rate meter event, the rate meter event to be determined by a rate meter associated with a network element in a software defined network (SDN) environment;
determining a requirement for a service provided by the network element is not met based on the rate meter event to be detected by the rate meter; and
causing a corrective action based on the requirement not met, the corrective action to cause the requirement to be met for the service provided by the network element in the SDN environment.

19. The computer-implemented method of claim 18, the network element comprising at least one of a virtual network function, a virtual connection, virtual switch, and a traffic class, and the service comprising at least one of a routing functionality, a firewall capability, a virtual Dynamic Host Control Protocol (vDHCP) capability, a virtual Network Address Translation (vNAT) capability, and a virtual Universal Plug and Play (vUPnP).

20. The computer-implemented method of claim 18, comprising causing the corrective action comprising at least one of migrating the network element from a first node to another node, migrating a different network element from the first node to another node, and reconfiguring a network element.

21. The computer-implemented method of claim 18, comprising determining the requirement not to be met based on at least one of an instantaneous throughput being greater than an instantaneous maximum threshold value, an instantaneous throughput being less than an instantaneous minimum threshold value, an average throughput being greater than an average maximum threshold value, and an average throughput being less than an average minimum threshold value.

22. The computer-implemented method of claim 18, the rate meter set to monitor instantaneous throughput of an egress port in the SDN environment, and to cause the rate meter event if at least one of the instantaneous throughput is greater than an instantaneous maximum threshold value and the instantaneous throughput is less than an instantaneous minimum threshold value.

23. The computer-implemented method of claim 22, the rate meter set to monitor average throughput of the egress port, and to cause the rate meter event if at least one of the average throughput is greater than a maximum average threshold value and the average throughput is less than a minimum average throughput.

24. The computer-implemented method of claim 18, the requirement comprising a service level agreement requirement and the rate meter set based on a service level agreement requirement for the network element, the service level agreement requirement to ensure at least one of a minimum throughput and a maximum throughput are maintained for the network element.

25. The computer-implemented method of claim 18, comprising enabling a user to set one or more rate meters in a traffic manager, each of the one or more meters to monitor at least one network element.
